(19) United States
(12) Patent Application Publication
(10) Pub. No.: US 2007/0169667 A1
(43) Pub. Date: Jul. 26, 2007

(54) Mold release/cleaner compositions

(75) Inventor: Zheng Lu, Glastonbury, CT (US)

Correspondence Address: HOFFMANN & BARON, LLP, 6900 JERICHO TURNPIKE, SYOSSET, NY, 11791, US

(73) Assignee: Henkel Corporation

(21) Appl. No.: 11/414,444

(22) Filed: Apr. 28, 2006

Related U.S. Application Data
(63) Continuation-in-part of application No. 10/565,499, filed on Jan. 23, 2006.

(51) Int. Cl. C04B 35/66

(52) U.S. Cl. 106/38.22; 524/104; 524/210; 510/200

(57) ABSTRACT

Mold release/cleaner compositions are provided which can be applied to mold surfaces and permit retention of high gloss finishes on the surfaces, while cleaning part-residue and maintain high release performance.

### CROSS-REFERENCE TO RELATED APPLICATIONS

This application is a continuation-in-part of U.S. patent application Ser. No. 10/565,499, filed Jul. 20, 2004, which claims the benefit of U.S. Provisional Application No. 60/490,321, filed Jul. 25, 2003, the contents of which are incorporated herein by reference.

### FIELD OF THE INVENTION

This invention generally relates to moisture and/or heat curing mold release cleaner compositions containing a cleaning-solvent which removes resin part residue from the mold without deleteriously affecting the mold release properties of the composition. The inventive compositions also contain a low-volatile organic (“low-VOC”) or non-volatile organic (“non-VOC”) component useful as a carrier for active components. More particularly, the present invention relates to mold release compositions, curable by exposure to moisture and/or heat, comprising a non-VOC, or low-VOC, carrier component, a curable component, which when applied as a coating cures to a finish having a high durability permitting multiple releases, and a cleaning-solvent component which cleans a mold surface without dissolving, removing or reacting with the curable component of the composition or its reaction product.

### BACKGROUND OF THE INVENTION

It is a common problem to encounter unwanted part-residue on molds resulting from the mold process. For example, mold formation of polyester or polyester-composite parts, such as boats and bathroom fixtures, require smooth, high gloss, defect free surfaces for proper functioning and/or aesthetic appearances. It is known that after a number of cycles, the resin used to form the part leaves residue, which builds up and creates surface defects which in turn affect the mold appearance and show up on the molded part. In order to obtain a high gloss surface in the molded part, a clean, high gloss mold surface must be retained over the life of the mold.

In an effort to overcome this problem, a number of mold cleaning compositions have been developed. For example, one such mold cleaning composition is sold commercially under the name Frekote™ PMC, by Henkel Corporation. This mold cleaner composition contains methyl ethyl ketone and toluene. Additionally, other commercially available mold release products include Frekote™ 915 WB, which contains primarily water and silicone earth such as Sillitin N85, for cleaning hard residue material from molds.

Mold cleaner compositions conventionally have been separate compositions from mold release compositions. Application of the mold cleaner is generally applied after use of a mold through various part-formation and release cycles.

Mold cleaning to retain the high gloss surface has required an interruption in the mold process and added expense in materials and production time.

There is a need for a composition, which provides for both mold release properties as well as mold cleaning properties, while also providing a composition which is environmentally acceptable, i.e., employs non- or low-volatile organic solvent (VOC) systems.

### SUMMARY OF THE INVENTION

The present invention is directed to moisture and/or heat curable mold release/cleaner compositions, as well as methods for preparing such compositions and applying such compositions to form mold release/cleaner coatings. Curable mold release compositions of the present invention include a non-volatile organic (non-VOC) carrier composition; a curable component containing a combination of at least one cross-linker and at least one polyfunctional siloxane; and a cleaning-solvent composition comprising at least one component capable of cleaning a mold surface, wherein the cleaning-solvent composition does not remove or react with the curable component or its reaction product. When applied as a coating, the mold release composition cures to a durability which permits at least five releases without transfer of mold release composition to a part.

In other embodiments of the present invention, the curable mold release/cleaner compositions include a low-volatile organic (low-VOC) carrier composition, which contains a combination of a non-VOC carrier and a VOC carrier, and a curable component containing a combination of at least one cross-linker and at least one polyfunctional siloxane; and a cleaning-solvent composition comprising at least one component capable of cleaning a mold surface, wherein the cleaning-solvent composition does not remove or react with the curable component or its reaction product.

In another embodiment of the invention there is provided a mold release/cleaner composition which includes:
a.) an organic carrier composition;
b.) a curable component comprising a combination of at least one cross-linker and at least one polyfunctional siloxane; and
c.) a mold-cleaner which does not remove or react with the curable component, said mold-cleaner comprising a nitrogenerated or oxygenated solvent for polymer resin residue.

In a further embodiment of the invention there is provided a mold release/cleaner composition which includes:
a.) an organic carrier composition;
b.) a curable component comprising a combination of at least one cross-linker and at least one polyfunctional siloxane; and
c.) a polymer residue cleaning-solvent which includes at least one compound which does not chemically interact with the curable component, said polymer residue cleaning solvent comprising at least one compound containing a functionally active oxygen or nitrogen.

In yet another embodiment of the invention there is provided a mold release/cleaner composition which includes:
a.) an organic carrier composition;
b.) a curable component which includes a combination of at least one cross-linker and at least one polyfunctional siloxane; and
c.) a mold-cleaning solvent which includes at least one compound selected from the group consisting of tertiary amines, fully substituted amides, acetates, ketones having no hydrogens on the carbons adjacent to the ketone group and combinations thereof.

The methods of the present invention for preparing curable release compositions include the steps of providing a carrier composition; and mixing the carrier composition with (i) a curable composition including at least on cross-linker and at least one polyfunctional siloxane; and (ii) a cleaning-solvent composition which includes at least one component capable of cleaning a mold surface, wherein the cleaning-solvent composition does not remove or react with the curable component or its reaction product.

The present invention is also directed to methods of preparing mold release/cleaner compositions and coatings made therefrom. Such methods include the steps of applying a mold release composition, which contains a carrier composition including a compound selected from branched, linear or cyclic siloxanes having 2-6 silicon atoms, branched, linear or cyclic fluorinated alkanes, and combinations thereof; a curable component which includes a combination of at least one cross-linker and at least one polyfunctional siloxane; a cleaning-solvent composition comprising at least one component capable of cleaning a mold surface, wherein the cleaning-solvent composition does not remove or react with the curable component or its reaction product; and allowing the composition to cure.

In another embodiment of the invention there is provided a method of making high gloss finish molded articles including:
a.) providing a polymer or metal mold;
b.) applying a mold release/cleaner composition to a mold surface which performs the molding action, said composition including:
   (i) an organic carrier composition;
   (ii) a curable component including a combination of at least one cross-linker and at least one polyfunctional silane; and
   (iii) a cleaning-solvent composition including at least one component capable of removing part-residue without removing or reacting with the curable component or its reaction product.
c.) performing at least one molding cycle on a polymer composition to form a composite part;
d.) permitting the cleaning solvent composition to interact with part-residue on the mold surface; and
e.) wiping the part-residue from the surface to leave behind the mold release/cleaner composition and retain a high gloss finish.

Methods of making the mold release/cleaner composition are also disclosed and include mixing together the components a.)-c.) of the aforementioned compositions.

### DETAILED DESCRIPTION OF THE INVENTION

The present invention is directed to moisture and/or heat curing mold release compositions that are durable and permit multiple releases when applied as a coating, and concurrently also provide a cleaning function to remove part residue from the mold during use. Methods for preparing such compositions are also disclosed. These compositions additionally may provide a high gloss finish when applied as a coating which is retained during use due to the cleaning function of the cleaning solvents incorporated therein. The mold release compositions of the present invention contain a non-VOC, or low-VOC, carrier component, thus reducing environmental problems caused by conventional VOC-containing solvent systems. The compositions also contain a curable active component, which may be moisture and/or heat curable, and which desirably includes at least one cross-linker and at least one hydroxy-functional siloxane. The compositions further contain a cleaner-solvent component, which removes mold part-residue without removing or reacting with the curable component or its reaction product.

The term “cure” or “curing,” as used herein, refers to a change in state, condition, and/or structure in a material that is usually, but not necessarily, induced by at least one variable, such as time, temperature, moisture, radiation, presence and quantity in such material of a curing catalyst or accelerator, or the like. The terms cover partial as well as complete curing.

The curable mold release/cleaner compositions of the present invention desirably are formed from a combination of an organic carrier component, such as a non-VOC carrier component, and a moisture and/or heat curing component. Desirable non-VOC carriers include siloxane compounds, which may be branched, linear, or cyclic; or fluorinated alkane compounds, which also may be branched linear, or cyclic; and combinations thereof.

Other useful non-VOC carriers include those non-reactive solvents that are environmentally friendly selected from the compounds listed by EPA as exempt from the definition of a Volatile Organic Compound in 40 C.F.R. § 51.100, which is hereby expressly incorporated herein by reference in its entirety. It would be understood by those of ordinary skill in the art which solvents from EPA's list are non-reactive and environmentally friendly, and thus, would be suitable for use in the compositions of the present invention. In addition, solvents having a vapor pressure of less than 0.1 mm Hg, which are non-volatile, also are considered non-VOC solvents for purposes of the present invention.

In accordance with the present invention, non-VOC solvents may be employed alone or in combination with other non-VOC solvents. In addition, it may be desirable to blend non-VOC solvents with VOC solvents as they evaporate slowly, thereby forming low-VOC carrier compositions. VOC organic carriers may include, for example, aliphatic or aromatic C₆₋₁₄ hydrocarbons.

Desirable room temperature evaporation rates for the solvents employed in the present invention are greater than about 0.01, more particularly ranging from about 0.01 to about 1,000,000 (butyl acetate=100). Other common solvent carriers have evaporation rates less than about 6,000 (butyl acetate=100). The carrier evaporation rate is determined by application and curing speed of the coating formulation. For instance, fast evaporating carriers may be preferred for room temperature applications, while slower evaporating carriers may be selected for higher temperature applications. Moreover, the evaporation rate of carriers also impacts the curing speed of the coating formulation.

In general, siloxane compounds contain silicon, oxygen, and usually carbon and hydrogen atoms. For purposes of the present invention, any methylated siloxane compound having 2-6 silicon atoms, such as methylated di-, tri-, tetra- and penta-siloxanes, may be useful as the non-VOC carrier component. The methylated siloxanes may be linear, branched, or cyclic compounds. Examples of specific siloxane compounds that may be used as carriers in accordance with the present invention include, but are not limited to: hexamethyldisiloxane, octamethyltrisiloxane, cyclotetrasiloxane, octamethylcyclotetrasiloxane, decamethyltetrasiloxane, decamethylcyclopentasiloxane and combinations thereof.

Also useful as non-VOC carrier components in accordance with the present invention are fluorinated alkanes. Similar to methylated siloxanes, these compounds also may be linear, branched, or cyclic. Examples of specifically useful fluorinated alkanes include, but are not limited to: 1,1,1,2-tetrafluoroethane and completely fluorinated alkane compounds.

Non-VOC carriers are present in the curable mold release compositions, for example, in an amount from about 1% to about 99.8% by weight of the total composition (w/w). Desirably, the non-VOC carrier is present in an amount from about 90% to about 99.8% w/w.

In some embodiments of the present invention, the mold release/cleaner composition may contain a carrier composition that is a combination of a non-VOC carrier and a VOC carrier, thereby providing a low-VOC carrier composition, as described above. The VOC carrier component may be any conventional VOC solvent used in mold release compositions, such as, for example, C₆ to C₁₄ aliphatic or aromatic solvents or mixtures thereof. The VOC carrier may be present in amounts from about 0 to about 95% w/w.

The mold release/cleaner compositions of the present invention also include a curable component, which is moisture and/or heat curable. Desirably, the curable component contains a combination of at least one cross-linking compound and at least one hydroxy-functional siloxane. For purposes of the present invention, the hydroxy-functional siloxane may be a polyfunctional siloxane. In particular, the polyfunctional siloxane may be one or more compounds of the following formula I: 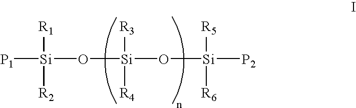
where R₁, R₂, R₃, R₄, R₅, and R₆ may be the same or different and may be alkyl, aromatic hydrocarbon, organoamine, fluorinated hydrocarbon, organo-alkoxy, hydro, organo-mercapto, organo-chloro, organo-cyano, or allyl; P₁ and P₂ may be the same or different and may be alkyl, hydroxyl, hydro, allyl, carbinol, amino, acetoxy, alkoxy, enoxy, or oxime groups; and wherein n is from 0 to about 100,000. Interruption of the polymer chain by a hetero atom is also within the scope of the present invention.

An example of a specific polyfunctional siloxane that may be used to form the above structure is hydroxy terminated polydimethylsiloxane, as represented by formula II:

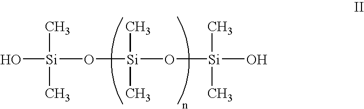

The number of repeating units, “n”, plays a role in determining the molecular weight and viscosity of the composition. Desirably, polydimethylsiloxanes incorporated into the mold release compositions of the present invention have a molecular weight of about 200 to about 400,000. Viscosity of the hydroxy terminated siloxane desirably ranges from about 50 to about 2,000,000 cps at room temperature. Hydroxy terminated siloxanes are present in the mold release compositions, for example, in an amount from about 0.01% to about 10% w/w.

The moisture and/or heat curable component also includes a cross-linking agent. Cross-linking is the attachment of two or more chains of polymers by, for example, bridges and cross bridges, comprising either an element, a group, or a compound. Suitable agents may be selected from a variety of crosslinkers, such as, but not limited to: a monomeric, cyclic, oligomeric or polymeric silazane, an amino-functional silazane, an enoxy-functional silazane, a silicon hydride, an alkoxy functional silane, a methylethylketoxime functional silane, an acetoxy functional silane, an enoxy functional silane, an amino-functional silane, and combinations thereof. More specifically, suitable crosslinkers include, but are not limited to: tris methylamino functional silane, tris enoxy functional silane, hydride functional silane, and cyclic trisilazane.

Cross-linking agents desirably are present in the mold release compositions of the present invention in an amount from about 0.01% to about 10% w/w, more desirably from about 0.01% to about 3% w/w. Moreover, it is desirable that the siloxane carrier component, if present, does not react with the crosslinker component in the compositions of the present invention.

The inventive composition also contains a cleaning-solvent composition which is capable of cleaning a mold surface, particularly where part-residue has been left behind, without deleteriously affecting the mold release properties. In particular, the cleaning-solvent composition must be capable of removing or otherwise cleaning the mold from part-residue. In some applications, the mold is made of a composite material, such as polyester. Various other polymers may be used as molds, as well as various metals. The compositions used to make the molded parts are also generally composite materials and may be selected from thermoplastic or thermoset compositions. For example, polyester- and styrene-based compositions are among those commonly used in applications for the automotive, household, electrical and boating industries. For many applications, the part material is a composite. For example, the hulls of boats and various other boating components may be molded using polyester composite compositions. These compositions often include fiberglass impregnated material. Applications useful in the household include such items as sinks, countertops and shower and bathtub combinations.

The polymer compositions used to make the parts often leave behind a small amount of residue each time the mold is used. After a number of cycles of molding parts, the residue buildup results in the loss of glossy finish, poor release performance and the production of parts with a poor surface finish. The cleaning-solvent composition used in the invention removes this residue and permits easy removal with simple wiping of the mold surface.

The cleaning solvent composition of the present invention may be selected from a wide variety of solvents, provided they do not deleteriously affect the curable component or its reaction products, i.e., the cured release coating. For example, various esters and acetates, such as the alkyl C₁₋₈ acetates may be employed. Examples are ethyl acetate and butyl acetate. Alkylester amides, such as N,N-dimethylacetamide may be used, provided they do not contain free —NH groups. Amidines such as 1,5-diazabicycle [4.3.0] non-5-ene, may also be employed. Various pyrrolo compounds, such as heterocyclic ether pyrrolo compounds are useful. For example, N-alkylated pyrroles, including N-methyl pyrrolidone may be used. Additionally, tertiary amines such as tripropylamine may also be employed. Combinations of these cleaning-solvent components are useful.

The cleaning-solvent compositions generally include oxygen-containing and/or nitrogen-containing organic solvents. For purposes of avoiding health and environmental problems, it is desirable not to use aromatic or halogenated solvents, although they would indeed function in the present invention.

The cleaning-solvent composition performs as a mold cleaner without deleteriously affecting the mold release properties of the composition. The mold release coating remains intact on the mold surface as the cleaning-solvent composition performs its dissolution of residue buildup from the parts. The residue then can easily be wiped off with a cloth without affecting the mold release characteristics and the mold retains its high gloss finish and release performance necessary to make high quality parts.

It has been noted that certain solvents which may perform an adequate cleaning function cannot be used in the inventive compositions due to their interaction with the curable component, which destroys or detracts from the release properties. Solvents such as alcohols, i.e., isopropyl alcohol; epoxy-containing materials, such as ethylene oxide-containing materials; aldehydes; ketones which form enol structures such as methyl ethyl ketone or acetone; carboxylic acids such as acidic acid; and primary and secondary amines are not useful due to their interaction with the curable component and detraction from the release properties of the final coating.

One or more cleaning-solvent components may be incorporated into the cleaning-solvent composition. For example, a combination of nitrogenated and oxygenated materials may be used. For example, one useful combination is NN-dimethylacetamide, N-methyl pyrrolidone and 2-ethylhexyl acetate each present in amounts of about 2% to about 50% by weight of the total composition. This combination is particularly effective at reducing part residue from polyester and styrene mold compositions, without destroying the glossy finish or the mold release characteristics of the overall mold release/cleaning composition. Thus, the choice of the cleaning-solvent composition components is based largely on their ability to be compatible with the overall composition, i.e., be incorporated into, be miscible with or otherwise dissolve with the overall composition, but not affect the release coating formed once the composition is cured.

Particularly useful nitrogen containing cleaning-solvent components are N-N-dimethylacidimide and N-methylpyrrolidone. A particularly useful oxygen-containing cleaning-solvent component is 2-ethylhexyl acetate.

It is desirable to have at least two cleaning-solvent components present, one of which is nitrogen and the other of which is oxygen. Such a combination has been found to produce particularly useful results, especially with parts made from polyester and/or styrene-containing compositions. The cleaning-solvent composition may be present in amounts from about 0.02% to about 30% by weight of the total composition. More particularly, the cleaning-solvent composition may be present in amounts of about 5% to about 25% by weight of the total composition and even more particularly in amounts of about 10% to about 20% by weight of the total composition. The combination of the various components for the solvent composition may be chosen from these ranges and depending on the type of residue to be cleaned from the mold, the ratio of oxygenated to nitrogenated components can be varied to achieve adequate cleaning and retain high gloss finish. The ratio of nitrogenated to oxygenated component depends on the nature of the residue required to be removed. For some embodiments of the present invention, the nitrogenated to oxygenated component ratio may be from 0.2:1 to 4:1.

The mold release/cleaner compositions of the present invention may contain a number of other additives, such as, catalysts, dyes, cure modifying agents, fillers, viscosity modifying agents, and combinations thereof. For example, it may be desirable to include a moisture catalyst to accelerate or otherwise promote the moisture cure process. Any conventional catalyst may be employed provided the mold release properties of the compositions are not compromised. Suitable catalysts that may be used include conventional organometallic catalysts such as organic titanium derivatives and organic tin derivatives, tertiary amine compounds, and certain early transition metal compounds. Generally, the catalyst is present in an amount from about 0 to 1.0% w/w. This concentration, however, may be varied depending upon the desired cure rate.

In accordance with the present invention, the mold release/cleaner compositions desirably are applied to a part to form a mold release/cleaner coating. Upon application, the compositions cure at room or elevated temperatures to form the mold release/cleaner coatings. The application of heat is not necessary in some embodiments of the present invention, however temperature may be used to affect curing speed. Thus, it may be desirable to apply heat, depending upon the components selected. In room temperature curing embodiments, cure time desirably ranges between about 2 minutes and about 48 hours. The cure time may be shortened upon addition of certain appropriate catalysts, as described above.

The compositions desirably cure to a high durability finish that permits a number of releases without contaminating a released part by transfer of the release composition from the mold to the part. Additionally, part-residue left on the mold is removed by the cleaner-solvent component and is easily removed by wiping. In addition, in some embodiments, the coating may desirably cure to a high gloss finish that permits a number of releases without measurable loss of initial gloss value. For example, the compositions of the present invention may cure to a finish having a gloss value of at least 80 as measured by a 60 degree gloss meter. After a number of releases, such as, for example at least five releases, this gloss value remains nearly the same. Any part-residue remaining on the mold is easily wiped off, preserving the high gloss finish. In addition, the finish remains sufficiently durable after the at least five releases such that the mold release/cleaner composition has not transferred to the part.

The present invention is also directed to methods for preparing curable mold release/cleaner compositions and coatings. According to these methods, a carrier composition containing a non- or low-VOC solvent is mixed with a moisture and/or heat curable composition, as defined above. This composition may be applied to a part and then permitted to cure, thereby providing a durable coating. The mold release/cleaner composition may be applied to the part by any conventional means, such as, but not limited to, wipe-on, spray-on, dipping, and rolling applications. These applications, particularly spray-on, cure to a high gloss with little or no need for buffing. The composition may be allowed to cure at room temperature or with application of heat depending upon the components selected. After curing, the coating permits a number of releases without measurable loss of gloss value or durability and any residue build-up is easily removed by wiping with a dry cloth to further preserve the high gloss finish.

### EXAMPLES

### Example 1

This example describes a formulation of components used to make a curable mold release composition of the present invention. Table 1 depicts the weight percent of each of the following components in the composition: tris methylamino functional silane; hydroxy functional siloxanes; C7-C₁₀ aliphatic solvents; and cyclic or linear methylated siloxanes. This combination formed a high gloss, room temperature moisture curing application.

TABLE 1

| Component | wt. % |
|---|---|
| Tris methylamino functional silane | 0.01-2 |
| Hydroxyl functional siloxanes | 0.02-8 |
| C₇-C₁₀ aliphatic solvents | 1-60 |
| Cyclic/linear methylated siloxanes | 60-99 |

The following gloss measurements were taken for the composition defined in Table 1: the clean mold; the mold after four coats of the release composition were applied; and the released part. The gloss measurements were obtained with a 60 degree gloss meter. Table 2 depicts the results, showing high gloss levels, which are all above 80.

TABLE 2

| | | Mold After Four | |
|---|---|---|---|
| | Clean Mold | Coats | Released Part |
| Gloss Number | 87.4 | 84.1 | 83.9 |

The release performance for this composition also was evaluated. In FIG. 1, release performance of this composition is depicted as release number as a function of ease of release. Ease of release was evaluated by observing the force needed to remove the part from the mold and assigning a rating based thereon. High ratings meant that essentially no force was needed to remove the part. FIG. 1 shows that the ease of release remained consistently high for about 40-45 releases. If desired, another coating of the release composition could be applied at this point to obtain an additional 40-45 releases.

### Example 2

This example describes a formulation of components used to make a curable mold release composition of the present invention. Table 3 depicts the weight percent of each of the following components in the composition: tris methylamino functional silane; cyclic trisilazane; hydroxy functional siloxanes; C₇-C₁₀ aliphatic solvents; and cyclic or linear methylated siloxanes. This combination formed a high gloss, room temperature moisture curing application.

TABLE 3

| Component | wt. % |
|---|---|
| Tris methylamino functional silane | 0.01-0.5 |
| Cyclic tri silazane | 0.01-1 |
| Hydroxyl functional siloxanes | 0.02-8 |
| C₇-C₁₀ aliphatic solvents | 1-50 |
| Cyclic/linear methylated siloxanes | 40-90 |

For this formulation, gloss numbers were measured for: the clean mold; the mold after four coats of the release composition were applied; and the released part. The gloss measurements were made with a 60 degree gloss meter. Table 4 depicts the results, showing high gloss levels which are all above 80.

TABLE 4

| | | Mold After Four | |
|---|---|---|---|
| | Clean Mold | Coats | Released Part |
| Gloss Number | 89.2 | 86.5 | 84.5 |

The release performance for this composition also was evaluated. In FIG. 2, release performance of this composition is depicted as release number as a function of ease of release. Ease of release was evaluated as described above in Example 1. FIG. 2 shows that the ease of release remained consistently high for about 40 releases for this formulation.

### Example 3

This example describes a formulation of components used to make a curable mold release composition of the present invention. Table 5 depicts the weight percent of each of the following components in the composition: tris methylamino functional silane; hydroxy functional siloxanes; C₇-C₁₁ aliphatic solvents; and 1,1,1,2-tetrafluoroethane. This formulation provided an aerosol form of the mold release composition for spray-on applications. In particular, 1,1,1,2-tetrafluoroethane is a non-VOC aerosol propellant.

TABLE 5

| Component | wt. % |
|---|---|
| Tris methylamino functional silane | 0.01-2 |
| Hydroxyl functional siloxanes | 0.05-7 |
| C₇-C₁₀ aliphatic solvents | 20-80 |
| 1,1,1,2-tetrafluoroethane | 60-99 |

### Example 4

This example describes a formulation of components used to make a curable mold release composition of the present invention. Table 6 depicts the weight percent of each of the following components in the composition: tris methylamino functional silane; hydroxy functional siloxanes; cyclic or linear methylated siloxanes; and 1,1,1,2-tetrafluoroethane. This formulation also provided a non-VOC aerosol form of the mold release composition. As described above, 1,1,1,2-tetrafluoroethane is a non-VOC aerosol propellant.

TABLE 6

| Component | wt. % |
|---|---|
| Tris methylamino functional silane | 0.01-2 |
| Hydroxyl functional siloxanes | 0.03-7 |
| Cyclic/linear methylated siloxanes | 10-70 |
| 1,1,1,2-tetrafluoroethane | 20-60 |

### Example 5

This example describes a formulation of components used to make a curable mold release composition of the present invention. Table 7 depicts the weight percent of each of the following components in the composition: tris methylamino functional silane; hydroxy functional siloxanes; cyclic or linear methylated siloxanes; and propane. Propane is a VOC propellant. This example provided a non-VOC aerosol formulation.

TABLE 7

| Component | wt. % |
|---|---|
| Tris methylamino functional silane | 0.01-2 |
| Hydroxyl functional siloxanes | 0.02-10 |
| Cyclic/linear methylated siloxanes | 10-70 |
| Propane | 20-60 |

### Example 6

This example describes a formulation of components used to make a curable mold release composition of the present invention. Table 8 depicts the weight percent of each of the following components in the composition: polysilazane; tris methylamino functional silane; hydroxy functional siloxanes; and cyclic or linear methylated siloxanes. This formulation provided a high temperature release application.

TABLE 8

| Component | wt. % |
|---|---|
| Polysilazane | 0.01-1 |
| Tris methylamino functional silane | 0.01-1 |
| Hydroxyl functional siloxanes | 0.03-10 |
| Cyclic/linear methylated siloxanes | 90-99 |

### Example 7

This example describes a formulation of components used to make a curable mold release composition of the present invention. Table 9 depicts the weight percent of each of the following components in the composition: tris enoxy functional silane; hydroxy functional siloxanes; C₇-C₁₁ aliphatic solvents; and linear or cyclic methylated siloxanes. This example provided a room temperature moisture curing application containing different crosslinkers.

TABLE 9

| Component | wt. % |
|---|---|
| Tris enoxy functional silane | 0.01-3 |
| Hydroxyl functional siloxanes | 0.02-10 |
| C₇-C₁₁ aliphatic solvents | 10-50 |
| Linear/cyclic methylated siloxanes | 20-90 |

### Example 8

This example describes a formulation of components used to make a curable mold release composition of the present invention. Table 10 depicts the weight percent of each of the following components in the composition: tris enoxy functional silane; hydride functional silane; hydroxy functional siloxanes; tin catalyst; and linear, branched, or cyclic methylated siloxanes. This formulation added a second cure mechanism, i.e., enoxy cure and hydride cure mechanisms.

TABLE 10

| Component | wt. % |
|---|---|
| Tris enoxy functional silane | 0.01-3 |
| Hydride functional silane | 0.01-1 |
| Hydroxy functional siloxanes | 0.02-10 |
| Tin Catalyst | 0.01-0.5 |
| Linear/branched/cyclic methylated | 80-99 |
| siloxanes | |

### Example 9

This example describes a formulation of components used to make a curable mold release composition of the present invention. Table 11 depicts the weight percent of each of the following components in the composition: cyclic trisilazane; hydroxy functional siloxanes; C₇-C₁₂ aromatic solvents; and completely fluorinated alkanes. This example provided a high temperature curing application.

TABLE 11

| Component | wt. % |
|---|---|
| Cyclic trisilazane | 0.05-10 |
| Hydroxyl functional siloxanes | 0.05-10 |
| C₇-C₁₂ aromatic solvents | 0-40 |
| Completed fluorinated alkanes | 20-90 |

### Example 10

This example describes a formulation of components used to make a curable mold release composition of the present invention. Table 12 depicts the weight percent of each of the following components in the composition: cyclic trisilazane; polysilazane; hydroxy functional siloxanes; C₁₂-C₁₆ aliphatic solvents; and linear, branched, or cyclic methylated siloxanes. The C₁₂-C₁₆ aliphatic solvents contained in this formulation have a vapor pressure of less than 0.1 mm Hg at 68° F. Thus, this formulation contained all non-VOC solvents.

TABLE 12

| Component | wt. % |
|---|---|
| Cyclic trisilazane | 0.04-15 |
| Polysilazane | 0.01-10 |
| Hydroxy functional siloxanes | 0.01-10 |
| C₁₂-C₁₆ aliphatic solvents | 1-50 |
| Linear/branched/cyclic methylated siloxanes | 1-50 |

### Example 11

Testing was carried out to compare the inventive formulation with commercially available Frekote™ WOLO and Frekote™ PMC as control samples. Since the invention is a unique type of product for the marketplace, there were no other cleaner/release products to use as controls. The inventive formulation, Cleaning Mold Release (CMR), was compared to commercially available Frekote™ WOLO (wipe on leave on release agent) and Frekote PMC (polymer mold cleaner) in terms of release, gloss, and surface finish at room temperature. These data are discussed below in addition to room temperature shelf life data.

Room Temperature Testing for Ten Releases

This example demonstrates the ability of the inventive mold release/cleaning compositions to provide a cleaning function, i.e., dissolve part-residue from the mold surface such that it can be easily wiped off. The compositions used are set forth in Table 13 below:

TABLE 13
(% Weight)

| Component | Inventive CMR | WOLO | PMC |
|---|---|---|---|
| Trismethyl methylaminosilane | 0.01-2 | 0.01-2 | 0 |
| Triscyclohexylmethylaminosilane | 0-1 | 0-1 | 0 |
| Cyclic trisilazane | 0.01-6 | 0.01-5 | 0 |
| Hydroxyl terminated siloxane | 0.01-5 | 0.01-6 | 0 |
| Isopar E | 1-60 | 1-80 | 0 |
| Isopar G | 1-60 | 1-80 | 0 |
| N,N-dimethyl acetamide | 0-30 | 0 | 0 |
| N-methyl pyrrolidone | 0-30 | 0 | 0 |
| 2-ethylhexyl acetate | 1-30 | 0 | 0 |
| Methyl ethyl ketone | 0 | 0 | 20-80 |
| Toluene | 0 | 0 | 20-80 |

Products: Low-VOC Pearl Gel Coat (Ashland)

Mold: 12″×24″ Orange Gel Coat panels

Molding parameters: Gel coat was applied to the mold at room temperature and allowed to set for at least 2 hours.

Application: Four coats of Frekote™ WOLO were wiped on the mold at room temperature. Each coat was allowed to cure for 10 minutes at room temperature, and the final coat was allowed to cure for 30 minutes. Ten releases were carried out with low-VOC pearl gel coat to build up styrene resin on the mold. The mold was then cleaned with CMR, WOLO, or PMC in the following manner: The formulation was applied to the mold with a clean cloth, and allowed to dissolve the residue on the mold for a few seconds. Another clean cloth was then used to remove the formulation and residue from the mold. As the cloth became saturated with residue, a new cloth was used to repeat the process until the residue is removed. The final step involves wiping the mold dry with another clean cloth.

Test Results:

Ease of Release with Low-VOC Pearl Gel Coat

| | 1st | 2nd | 3rd | 4th | 5th |
|---|---|---|---|---|---|
| Composition | Release | Release | Release | Release | Release |
| CMR | 5 | 5 | 5 | 5 | 5 |
| WOLO | 5 | 5 | 5 | 5 | 5 |
| PMC | 0 | 0 | 0 | 0 | 0 |
| | 6th | 7th | 8th | 9th | 10th |
| Composition | Release | Release | Release | Release | Release |
| CMR | 5 | 5 | 5 | 5 | 5 |
| WOLO | 5 | 5 | 5 | 5 | 5 |
| PMC | 0 | 0 | 0 | 0 | 0 |

Gloss Measurements With Low-VOC Pearl Gel Coat

| | | | 1st Release | | 2nd Release | | 3rd Release | |
|---|---|---|---|---|---|---|---|---|
| | Gloss, | Gloss, Mold + | Gloss, | Gloss, | Gloss, | Gloss, | Gloss, | Gloss, |
| Formulation | Clean Mold | Rel. Agent | Mold | Part | Mold | Part | Mold | Part |
| CMR | 87.6 | 82.9 | 80.1 | 78.8 | 77.3 | 77.4 | 78.7 | 72.9 |
| WOLO | 86.0 | 84.5 | 79.0 | 81.3 | 80.4 | 79.2 | 77.0 | 77.6 |
| PMC | 85.2 | 83.7 | N/A | N/A | N/A | N/A | N/A | N/A |

| | 4th Release | | 5th Release | | 6th Release | | 7th Release | |
|---|---|---|---|---|---|---|---|---|
| | Gloss, | Gloss, | Gloss, | Gloss, | Gloss, | Gloss, | Gloss, | Gloss, |
| Formulation | Mold | Part | Mold | Part | Mold | Part | Mold | Part |
| CMR | 73.5 | 75.7 | 74.4 | 76.1 | 72.6 | 75.0 | 70.2 | 74.3 |
| WOLO | 74.7 | 75.5 | 73.5 | 74.9 | 72.3 | 74.0 | 73.8 | 70.1 |
| PMC | N/A | N/A | N/A | N/A | N/A | N/A | N/A | N/A |

| | | |
|---|---|---|
| 8th Release | 9th Release | 10th Release |

| | Gloss, | Gloss, | Gloss, | Gloss, | Gloss, | Gloss, |
|---|---|---|---|---|---|---|
| Formulation | Mold | Part | Mold | Part | Mold | Part |
| CMR | 70.5 | 72.2 | 68.4 | 70.0 | 68.9 | 68.3 |
| WOLO | 70.0 | 71.8 | 68.6 | 67.7 | 67.1 | 66.0 |
| PMC | N/A | N/A | N/A | N/A | N/A | N/A |

Note:
N/A = not available due to no release.

The table entitled “Ease of Release with Low-VOC Pearl Gel Coat” compares the ease of release based on the following scale:
0. Not Tested
1. Mold Damage
2. Failed-No Release
3. Difficult Release
4. Borderline Release
5. Slight Assistance for Release
6. Spontaneous Release (No Force)

As demonstrated in the table, the inventive compositions performed equally as well (a “5” rating) as the commercial composition designed specifically only for release properties. The commercial composition (PMC), designed only to clean, was not tested since it had no components designed to enhance mold release.

Furthermore, as demonstrated in the table entitled “Gloss Measurements with Low-VOC Pearl Gel Coat”, the inventive compositions were again compared to the commercially available release composition (WOLO) and cleaning composition (PMC), this time based on gloss measurements. The higher the gloss number is based on a 0-100 scale, with zero having no light refraction and one hundred (100) being a nearly perfect gloss finish with high light refraction. Measurements are made using a 60° glossmeter.

As indicated form the table, the inventive composition (CMR) yielded equivalent gloss readings as compared to the commercial formulation (WOLO) designed only for cleaning.

Thus, the above tables indicate, after ten mold cycles, that the inventive compositions provide both mold release properties as well as cleaning properties, both of which properties are at least as good as commercially available compositions designed to perform the individual functions of releasing or cleaning.

### Example 12

### Shelf Life Testing

Products: Low-VOC Pearl Gel Coat (Ashland)

Mold: 12″×24″ Orange Gel Coat panels

Molding parameters: Gel coat was applied to the mold at room temperature and allowed to set for at least 2 hours.

Application: Four coats of WOLO were wiped on the mold at room temperature. Each coat was allowed to cure for 10 minutes at room temperature, and the final coat was allowed to cure for 30 minutes. Ten releases were carried out with low-VOC pearl gel coat to build up styrene resin on the mold. The mold was then cleaned with a freshly prepared sample of CMR and samples that were aged at room temperature for 6 months in 2 months increments. The mold was cleaned in the following manner: The formulation was applied to the mold with a clean cloth, and allowed to dissolve the residue on the mold for a few seconds. Another clean cloth was then used to remove the formulation and residue from the mold. As the cloth became saturated with residue, a new cloth was used to repeat the process until the residue was removed. The final step involved wiping the mold dry with another clean cloth.

Test Results:

Shelf Life Testing at Room Temperature
Ease of Release with Low-VOC Pearl Gel Coat

| | 1st | 2nd | 3rd | 4th | 5th |
|---|---|---|---|---|---|
| Formulation | Release | Release | Release | Release | Release |
| CMR | 5 | 5 | 5 | 5 | 5 |
| CMR 2 Months | 5 | 5 | 5 | 5 | 5 |
| CMR 4 months | 5 | 5 | 5 | 5 | 5 |
| 6 months | 5 | 5 | 5 | 5 | 5 |

As indicated in the shelf life table above, the inventive composition continued to provide excellent release after 2, 4 and 6 months of aging on parts at room temperature.

What is claimed is:

1. A mold release/cleaner composition comprising:
a.) an organic carrier composition;
b.) a curable component comprising a combination of at least one cross-linker and at least one polyfunctional siloxane; and
c.) a cleaning-solvent composition comprising at least one component capable of cleaning a mold surface, wherein the cleaning-solvent composition does not remove or react with the curable component or its reaction product.

2. The composition of claim 1, wherein the cleaning-solvent composition comprises an oxygenated or nitrogenated compound.

3. The composition of claim 1, wherein the cleaning-solvent composition comprises at least one oxygenated compound and at least one nitrogenated compound.

4. The composition of claim 1, wherein the cleaning-solvent composition comprises a component selected from the group consisting of alkyl C₁₋₈ esters or acetates; alkylester amindes which do not contain free —NH groups; amidines; heterocyclic ether pyrrole compounds; and combinations thereof.

5. The composition of claim 1, wherein the cleaning-solvent composition comprises N,N-dimethyl acetamide, N-methyl pyrrolidone and 2-ethylhexyl acetate.

6. The composition of claim 1 having a durability of at least five releases without measurable loss of gloss value.

7. The composition of claim 1, wherein said organic carrier composition comprises a compound selected from the group consisting of branched, linear or cyclic siloxanes having 2-6 silicon atoms; branched linear or cyclic fluorinated alkanes; and combinations thereof.

8. The composition of claim 7, wherein said siloxane carrier comprises a completely methylated siloxane.

9. The composition of claim 1, wherein said organic carrier composition is present in amounts of about 1% to about 99.8% by weight of the total composition.

10. A mold release/cleaner composition comprising:
a.) an organic carrier composition;
b.) a curable component comprising a combination of at least one cross-linker and at least one polyfunctional siloxane; and
c.) a mold-cleaner which does not remove or react with the curable component, said mold-cleaner comprising a nitrogenerated or oxygenated solvent for polymer resin residue.

11. The composition of claim 10, wherein the mold cleaner comprises a component selected from the group consisting of alkyl C₁₋₈ esters or acetates; alkylester amindes which do not contain free —NH groups; amidines; heterocyclic ether pyrrole compounds; and combinations thereof.

12. The composition of claim 10, wherein the mold cleaner comprises N,N-dimethyl acetamide, N-methyl pyrrolidone and 2-ethylhexyl acetate.

13. The composition of claim 10 having a durability of at least five releases without measurable loss of gloss value.

14. The composition of claim 10, wherein said organic carrier composition comprises a compound selected from the group consisting of branched, linear or cyclic siloxanes having 2-6 silicon atoms; branched linear or cyclic fluorinated alkanes; and combinations thereof.

15. The composition of claim 10, wherein said organic carrier composition is present in amounts of about 1% to about 99.8% by weight of the total composition.

16. The composition of claim 10, wherein the mold cleaner comprises a component selected from the group consisting of alkyl C₁₋₈ esters or acetates; alkylester amindes which do not contain free —NH groups; amidines; heterocyclic ether pyrrole compounds; and combinations thereof.

17. The composition of claim 10, wherein the mold cleaner comprises N,N-dimethyl acetamide, N-methyl pyrrolidone and 2-ethylhexyl acetate.

18. The composition of claim 10 having a durability of at least five releases without measurable loss of gloss value.

19. A mold release/cleaner composition comprising:
a.) an organic carrier composition;
b.) a curable component comprising a combination of at least one cross-linker and at least one polyfunctional siloxane; and
c.) a polymer residue cleaning solvent comprising at least one compound which does not chemically interact with the curable component, said polymer residue cleaning solvent comprising at least one compound containing a functionally active oxygen or nitrogen.

20. A method of making high gloss finish molded articles comprising:
a.) providing a polymer or metal mold;
b.) applying a mold release/cleaner composition to a mold surface which performs the molding action, said composition comprising:
(i) an organic carrier composition;
(ii) a curable component comprising a combination of at least one cross-linker and at least one polyfunctional silane; and
(iii) a cleaning-solvent composition comprising at least one component capable of removing part-residue without removing or reacting with the curable component or its reaction product.
c.) performing at least one molding cycle on a polymer composition to form a plastic part;
d.) permitting the cleaning solvent composition to interact with the part-residue on the mold surface; and
e.) wiping the part-residue from the surface to leave behind the mold release/cleaner composition and retain a high gloss finish.

21. The method of claim 20, wherein the polymer composition used to make the part and which results in part-residue on the mold surface is a styrene- or polyester-containing composition.

22. The method of claim 20, wherein the mold comprises a polyester mold surface.

23. A mold release/cleaner composition comprising:
a.) an organic carrier composition;
b.) a curable component comprising a combination of at least one cross-linker and at least one polyfunctional siloxane; and
c.) a mold cleaning solvent comprising at least one compound selected from the group consisting of tertiary amines, fully substituted amides, acetates, ketones having no hydrogens on the carbons adjacent to the ketone group and combinations thereof.
